(19) United States
(12) Patent Application Publication
(10) Pub. No.: US 2007/0131759 A1
(43) Pub. Date: Jun. 14, 2007

(54) SMARTCARD AND MAGNETIC STRIPE EMULATOR WITH BIOMETRIC AUTHENTICATION

(76) Inventors: Mark Alan Cox, West Chester, PA (US); John Kenneth Bona, York, PA (US)

Correspondence Address: Dennis M. Carleton, Esquire;Buchanan Ingersoll PC, One Oxford Centre, 20th Floor, 301 Grant Street, Pittsburgh, PA, 15219, US

(21) Appl. No.: 11/456,906

(22) Filed: Jul. 12, 2006

Related U.S. Application Data
(60) Provisional application No. 60/750,270, filed on Dec. 14, 2005.
(60) Provisional application No. 60/785,329, filed on Mar. 22, 2006.
(60) Provisional application No. 60/804,615, filed on Jun. 13, 2006.

(51) Int. Cl. G06K 5/00; G06K 15/00

(52) U.S. Cl. 235/380; 235/383

(57) ABSTRACT

A handheld unit which is capable of emulating a plurality smartcards or magnetic stripe cards. The unit has the capability of storing a plurality of data sets representing a plurality of accounts. The unit is equipped with a near field communications interface that can emulate a smartcard interface that is capable of communicating with smartcard readers at POS or ATM terminals, or anywhere else a smartcard may be utilized. The unit is equipped with a biometric sensor to positively verify an authenticated user

### RELATED APPLICATIONS

This application claims the benefit of U.S. provisional application Ser. No. 60/750,270, filed Dec. 14, 2005, U.S. provisional application 60/785,329, filed Mar. 22, 2006, both entitled “Biometric RFID Storage Device Used for Contactless Transactions”, and U.S. provisional application 60/804,615, filed Jun. 13, 2006, entitled “Smartcard and Magnetic Stripe Emulator With Biometric Authentication.”

### BACKGROUND OF THE INVENTION

Radio frequency identification devices (RFID) are well known in the art. A typical RFID device includes an antenna and a chip that is activated by RF energy emitted by a reading device. The antenna on the reading device induces a signal into an RFID chip which is in close proximity to the reading device, causing the RFID device it to transmit a small amount of data back to the reading device. An RFID tag can be thought of as similar in usefulness to a bar code.

RFID has found its way into many applications, including inventory control and tracking, as substitutes for traditional magnetic strip cards for electronic payments at point of sale (POS) locations, devices for automatically paying tolls on highways, passports and personal identification cards. RFID devices have even been used as embedded devices within living beings such as domesticated pets and children.

A “smartcard” is a card that is embedded with either a microprocessor and a memory chip or a memory chip with non-programmable logic. The microprocessor can add, delete, and otherwise manipulate information on the card, while a memory-chip card can only undertake a pre-defined operation. Although smartcards utilize radio frequency (RF) to transmit and receive data, they are unlike traditional RFID tags or magnetic strip cards in that all necessary functions and information necessary for the completion of a transaction can be carried on the card. Therefore, they do not require access to remote databases at the time of the transaction. Smartcards are governed by many standards, in particular, ISO/IEC standards 7816 and 14443.

The smartcard is quickly replacing the traditional method of ‘swiping’ credit cards with data contained on magnetic stripes. At a point-of-sale (POS), the smart card is activated by a contactless reader attached to an external device required for the application, for example, an RFID reader attached to a cash register. The reader's RF antenna induces a signal into the card's RF antenna, thereby activating the smart card. The application can then communicate with the smart card via the reader unit to transmit the cardholder's account data back to the point of sale application, utilizing a command set specified by the ISO 7816 standard.

While smart cards allow transactions to be performed at a faster rate than traditional magnetic stripe cards, they only offer a small improvement in security to guard against account data theft than the conventional magnetic stripe credit cards they are replacing. A closer examination of this technology reveals several inadequacies that will allow fraudulent and illegal trends to emerge. First, owners making a purchase no longer enter PIN numbers or sign a printed copy of the credit card transaction. Therefore, if a smartcard is lost or stolen, it can be used to make unauthorized purchases. Also, there are new security threats that are technically possible against contactless smart cards. A lost or stolen smart card also contains all the required information thereon, including the account number, CCV and any other information necessary to complete a transaction, that can be easily read and copied Differential Power Analysis (DPA) and Simple Power Analysis (SPA) may be used to steal the security keys for communication encryption and decryption. In addition, smartcards are subject to certain types of attacks, known as “relay” attacks, in which a smartcard not in close proximity to a POS-based reader can be used by “relaying” its information through another reader and smartcard pair.

These deficiencies represent a dramatic financial threat to both the issuing institutions and the card owners. While credit card companies and insurance companies that underwrite fraud coverage usually absorb the losses associated with fraudulent activity, the long-term implications for victims and their credit ratings are very serious. Additionally, it is intuitive that any perceived security risk associated with smartcard technology would represent an obstacle to widespread market acceptance. Therefore, it would be advantageous to provide a means of securing the data stored within smartcards from being covertly and illegally harvested.

### SUMMARY OF THE INVENTION

The present invention is a cost effective device capable of storing the information from multiple smartcards and data from multiple conventional magnetic stripe cards for use either through a magnetic stripe emulator or as a ‘virtual’ contactless smartcard, and preventing both unauthorized use of the device and outright theft of the information on the device via a biometric recognition technology, such as, for example, fingerprint verification or voice recognition. In this capacity, the theft of account data via relay attack, as well as crimes associated with lost or stolen smartcards, will be virtually eliminated.

In the preferred embodiment, the present invention is comprised of two components, a PC application and a handheld portable data storage device. Optionally, an associated base unit may also be provided.

The handheld device, in the preferred embodiment, is roughly the size of a credit card, approximately 10 mm thick, and contains an LCD display and a numeric keypad, as well as several navigation buttons, namely a four way pushbutton with a central “enter” pushbutton, to navigate through the applications and make appropriate selections. Optionally, a portion of the device also contains a programmable magnetic stripe and conforms to the ISO 7813 standard of 0.76 mm in thickness.

The device incorporates a near field communications (NFC) capability which is also compatible with the ISO 14443 standard. NFC is a peer-to-peer connection that allows the transfer of larger amounts of data than a simple query and reply smartcard. The NFC capability can emulate a smartcard. The NFC capability may also be used for downloading various data to device, such as electronic receipts, coupons, advertising content, etc. Additionally, the device is capable of communicating with NFC-enabled POS terminals, for purposes of transmitting account information, coupon information, and other types of information to the POS terminal, and can also received information, such as an electronic receipt, from the POS terminal. Additionally, the device will be able to communicate with other NFC-enabled devices, such as kiosks, where discount coupons may be available, and ticketing agents, where event tickets may be purchased and stored electronically until their use

Most importantly, the device also incorporates a biometric sensor for performing fingerprint or voice recognition to positively identify the user of the device. This provides the means to ensure that only the authorized card owner is actually performing the transaction. In the preferred embodiment, fingerprint verification is used to biometrically identify the authorized user, however, other means of identifying the users, both biometric and non-biometric may also be used. Authentication is required for each transaction, and the identity of the authorized user must be verified before the device's NFC circuitry is activated, and its signal transmitted to an RFID reader or NFC-enabled POS terminal. Authentication may not be required for all functions of device For example, it may not be desirable to require authentication for the downloading of coupons.

The handheld device and the optional base unit contain mating connectors which allow rechargeable batteries in the handheld device to be recharged. In addition, the base may contain an NFC reader, such that the base can act as an NFC-enabled POS terminal for internet purchases.

The handheld device will communicate with an application running on a PC either through a cable directly connecting the handheld device and the PC, such as a USB cable, through the base unit, or via a wireless connection, such as Bluetooth. The PC application allows the storing of various account information and data, and can be synchronized with the handheld device when they are connected such that the data on the PC mirrors the data on the handheld device. The PC application will also provide other functionality which will be discussed in detail herein.

The handheld device can also emulate a magnetic stripe card by utilizing a programmable magnetic stripe which can be re-programmed on the fly and which can be erased after a pre-determined period of time for security purposes. Account information from cards having a magnetic stripe may be transmitted via an RF signal, in the event that an RF reader is available at the POS terminal. In this fashion, conventional magnetic stripe card owners will be able to perform transactions at venues utilizing the more desirable contactless, RF technology. The device contains ample memory to store account information from multiple conventional magnetic stripe cards and smartcards.

The handheld device must be initialized prior to the downloading of account information. The initialization process begins with a user enrollment step, in which the user is prompted to place a fingertip on the biometric sensor. The fingerprint is then scanned, converted into a digital template, and stored in the memory of the handheld device. The fingerprint template can then be used for the authentication and activation process prior to any RF signal transmission. Multiple users can be enrolled to use the various accounts stored on the card.

Use of an account stored on the device depends upon the user selecting a particular account and then authorizing its use through a biometric authentication process. To authenticate, the user places the same finger on the biometric sensor that was used to create the stored digital fingerprint template. In this capacity, any unauthorized use of the card is prohibited, thereby adding a new level of security to transactions with both conventional and smartcards.

One shortcoming of fingerprint recognition is that a small percentage of the population lacks a ‘usable’ fingerprint pattern for this purpose. In such cases, the users will have the ability to enter a personal identification number (PIN) as an alternate method of authentication. During initialization the user will be prompted to select either fingerprint or PIN for authentication. Once the PIN is entered the device will store the selected application data set in memory. Alternative biometric technologies could also be used in place of the fingerprint scan. The most obvious alternative would be voice recognition.

For security purposes and to prevent certain types of security attacks on device 100. The RF antenna in the device is disabled after a single use. Without an enabled antenna the interrogating RF signal won't be received and the device will not transmit a signal. When a subsequent transaction is desired, and the authentication process is completed, the antenna is re-enabled for a time sufficient to complete the transaction then automatically disabled again, or for a single transmission of the data. For transactions involving a magnetic stripe, the programmable magnetic stripe on device 100 is erased after a predetermined period of time to prevent re-use. The device may also contain circuitry to record and time-stamp all attempts at retrieving data, including both authenticated attempts and attempts to use the device without authentication.

The device may also be equipped with a camera of the type frequently found on cellular telephones. The camera may be used to capture information from coupons by taking a photo of the coupon's barcode. The device is equipped with barcode reading software which is able to read the bar code from the captured photograph and display the information to the user in plain-text.

The inventors envision other types of biometric methods used with the device for authentication, including but not limited to, voice recognition, skin resistance and skin capacitance, and any other type of biometric verification now known or later invented.

### BRIEF DESCRIPTION OF THE DRAWINGS

FIG. 1 shows front, back and side views of the device of the preferred embodiment of the invention.

FIG. 2 shows a view of the bottom edge of the device.

FIG. 3 shows the optional base unit of the invention.

FIG. 4 is a schematic of the architecture of the device.

FIG. 5 is a flow chart showing the enrollment of a user on the handheld device.

FIG. 6 is a flow chart showing the device provisioning process wherein account data is downloaded from account issuers.

FIG. 7 is a flow chart showing the activation of an account stored on the device.

FIG. 8 is a flow chart for the software application which is stored on the device.

FIG. 9 is a functional diagram of the menu structure of the software application running on the handheld device.

FIG. 10 is a functional diagram of the application running on the personal computer.

FIG. 11 is a first example of a device and reader application.

FIG. 12 is a second example of a device and reader application.

### DETAILED DESCRIPTION OF THE INVENTION

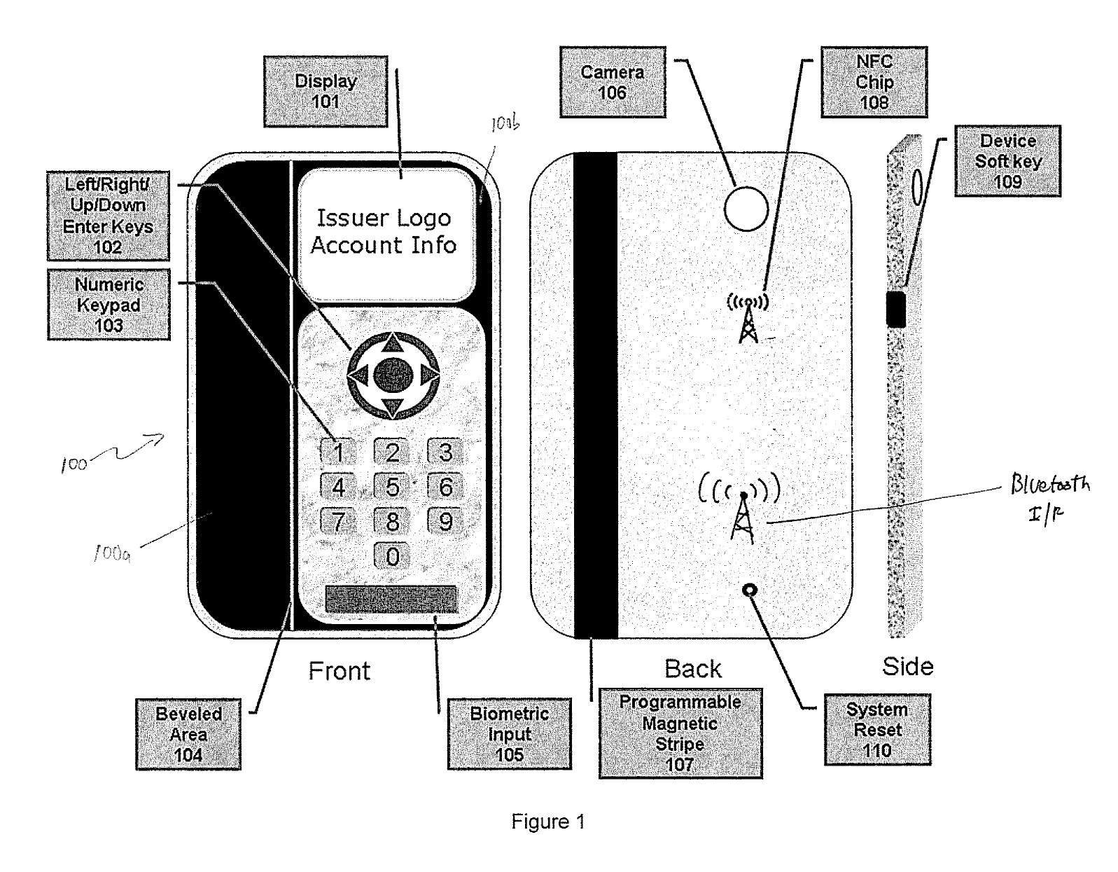

FIG. 1 shows front, back and side views of the exterior of the device, which contains two portions, thinner portion 100a and thicker portion 100b. Thicker portion 100b preferably is about 10 mm thick and may be composed of any material commonly used for housing electronic devices, but is preferably composed of a material that will not interfere with the transmission or reception of RF signals. The front of device 100 contains an LCD display 101 as well as menu selection keys 102 and numeric keypad 103. Menu selection keys 102 facilitate navigation through a series of menus displayed on display 101. Menu selection keys 102 consist of directional keys, which may be used move a cursor up, down, left or right, while a central ENTER key may be used to select menu items. The directional keys and ENTER key may be of any configuration.

Thinner portion 100a of device 100 contains a magnetic stripe 107 and is preferably approximately 76 mm in thickness, in accordance with ISO standard 7813. The thickness of portion 100a of device 100 is such that it can be passed through a typical magnetic stripe card reader. Between sections 100a and 100b is a beveled area 104 which makes the transition from the thin portion of device 100 to the thick portion. The thinner portion 100a of device 100 and magnetic stripe 107 are optional. It is envisioned that future versions of the device will be made without the magnetic stripe 107, as magnetic stripe credit cards and readers are phased out in favor of contactless transaction devices. In such cases, thinner portion 100a of device 100 may be absent.

Also located on the front of device 100 is biometric input sensor 105 which, in the preferred embodiment, consists of a fingerprint scanner. In other embodiments of the invention, other biometric authentication devices may also be used, such as voice recognition, skin pH analysis, or any other means of identifying the user, now known or later invented. In addition, the biometric authentication may be replaced an alphanumeric password or PIN that the user may enter into the device using numeric keypad 103.

The rear of the device contains the programmable magnetic stripe 107 situated on the thin portion 100a of device 100. Also located on the back of the device is camera 106 which is used primarily in the preferred embodiment for taking photographs of barcodes which can be read through barcode recognition software, however, any images may be captured and stored on the device for display or transmission. In addition, NFC chip 108 and Bluetooth chip 109 are shown on the rear of the card. However, these chips are actually internal to the device. Also located on the back of device 100 is a system reset button 110.

The side view of the device in FIG. 1 shows device soft key 109, which is used by the user to interact with the software application programmed into the device.

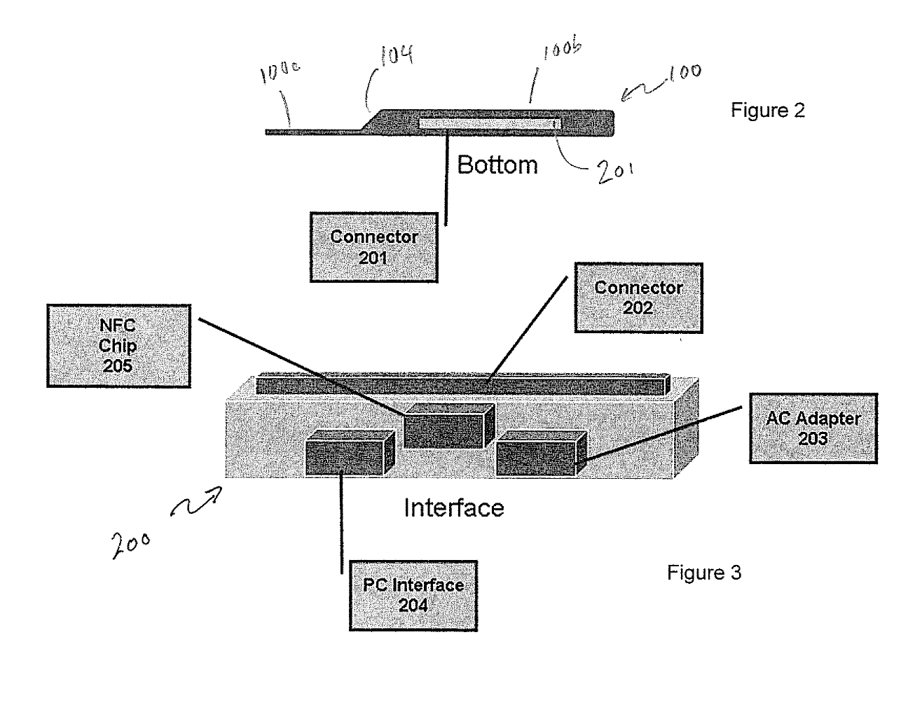

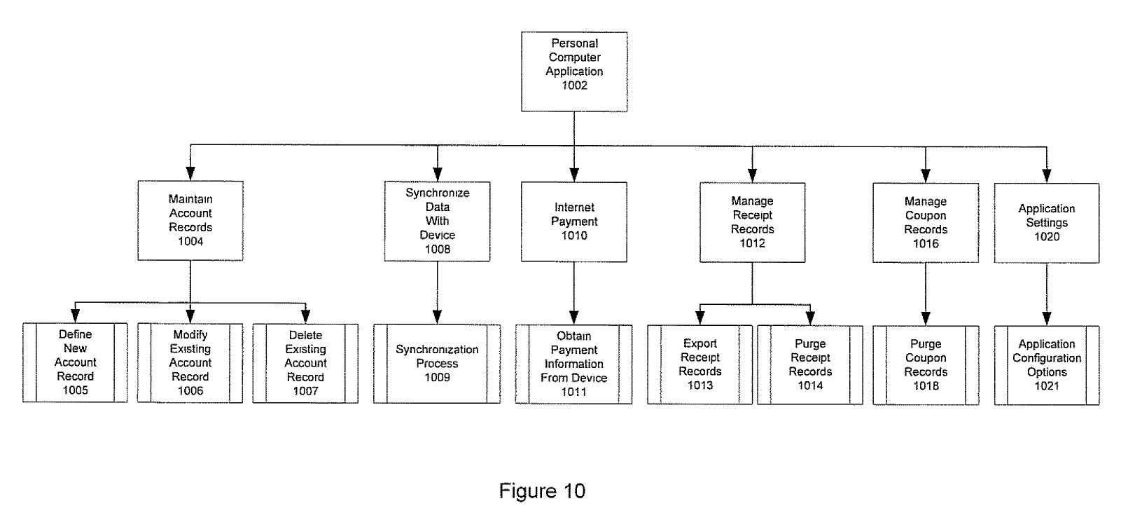

FIG. 2 shows the bottom of device 100 showing thin area 100a having the magnetic stripe 107 disposed thereon, thicker area 100b and the beveled transition 104 therebetween. Also present on the bottom of device 100 is connector 201 which may be used to transfer data to and from PC application 1002, shown in FIG. 10, via a direct cable connection or via base unit 200.

Optional base unit 200, shown in FIG. 3, contains connector 202 which mates with connector 201 on the bottom of device 100 to provide the aforementioned functions. Base unit 205 also contains an NFC chip 205, which will allow base unit 200 to act as an NFC-enabled point-of-sale terminal for purchases made on-line. Also present on base 200 is PC interface 204, which allows device 100 to communicate with PC application 1002. The means for allowing device 100 to communicate with PC application 1002 may also be any one of a number of wireless transfer protocols well known in the art. Such as Bluetooth.

Connector 201 may be used to charge rechargeable battery 405 within device 100, either via a connection to base unit 200 or via a direct cable connection to a PC. AC adapter 203 for base unit 200 may provide power for re-charging battery 405.1 Alternatively, battery 405 may be inductively charged via voltages induced on the RF antenna of the device through interaction with an electromagnetic field.

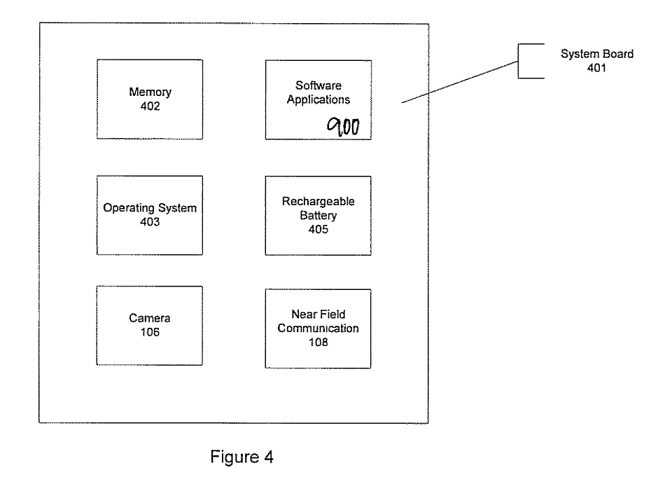

FIG. 4 is a schematic architectural diagram of the internals of device 100. System board 401 is contained within the device and contains thereon memory 402 in which is stored operating system 403 and on-board software application 404.

Also situated on system board 401 is camera 106, NFC chip 108, Bluetooth interface 406 and rechargeable battery 405.

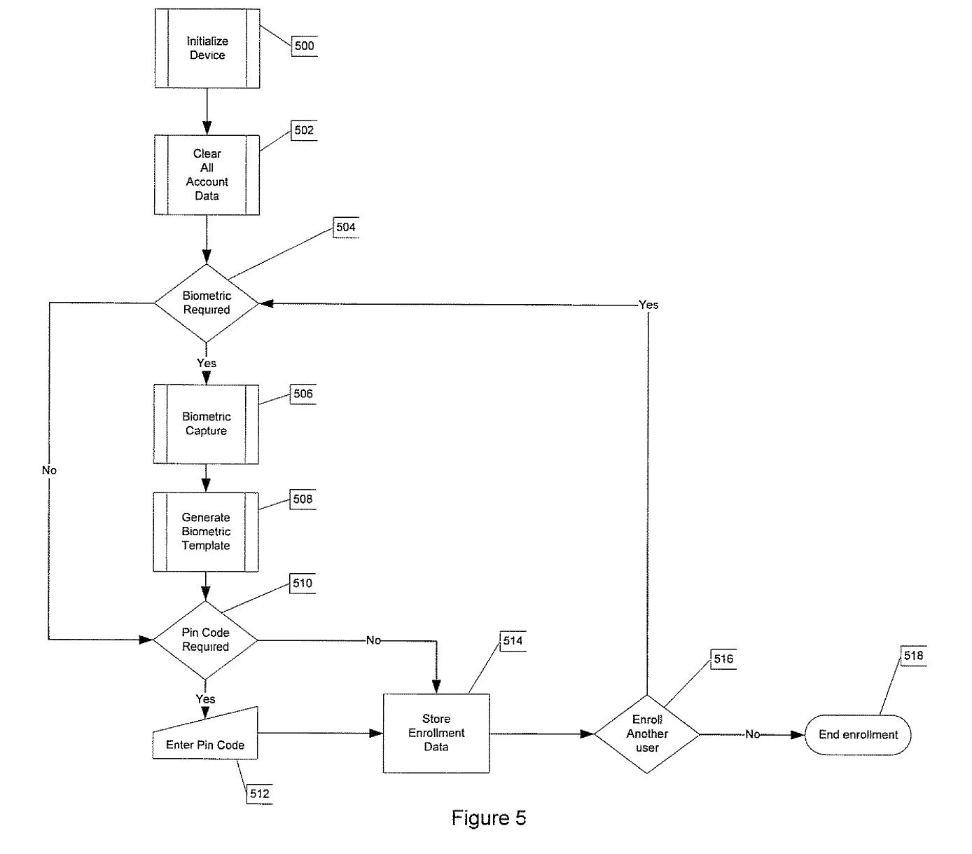

FIG. 5 shows the process by which users are enrolled on device 100. In box 500, the initialize device process is begun and in box 502, the portion of the memory containing the stored account information and all other user data is cleared, to prevent an unauthorized person in physical possession of the unit from adding an authorized user to already existing accounts stored in the device. In box 504, it is determined if a biometric is required, preferably by asking the user. If so, the biometric capture procedure is performed in box 506 and a biometric template is generated and stored in memory 402 in box 508. In box 510 it is determined if a personal identification number (PIN) is required in addition to or in lieu of the biometric. In box 504, if it is determined that a biometric is not required, flow proceeds to box 510 and continues as before. If a PIN is required, the PIN is entered by the user using numeric keypad 103 in box 512. Once the biometric enrollment process is complete, the enrollment data is stored to memory in box 514 and in box 516 it is determined if another user is to be enrolled. If so, control is returned to box 504. However, if not, the user enrollment process is complete in box 518.

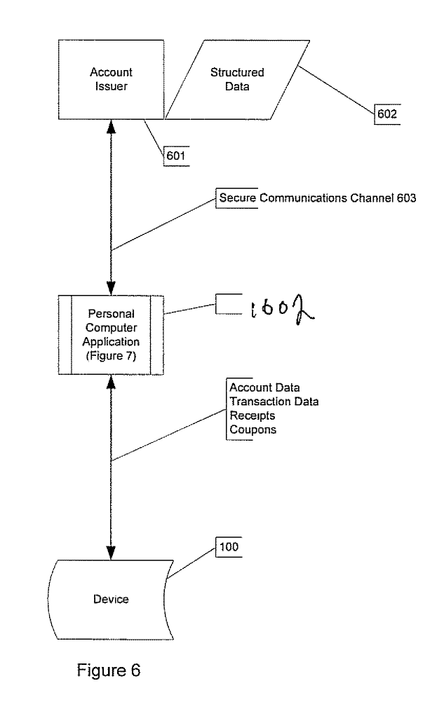

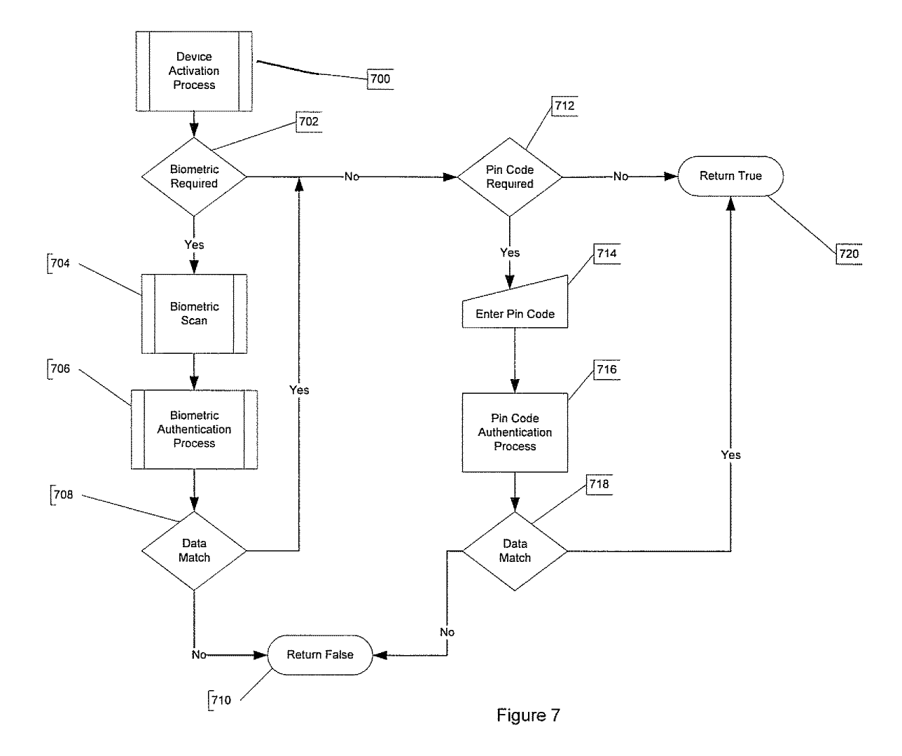

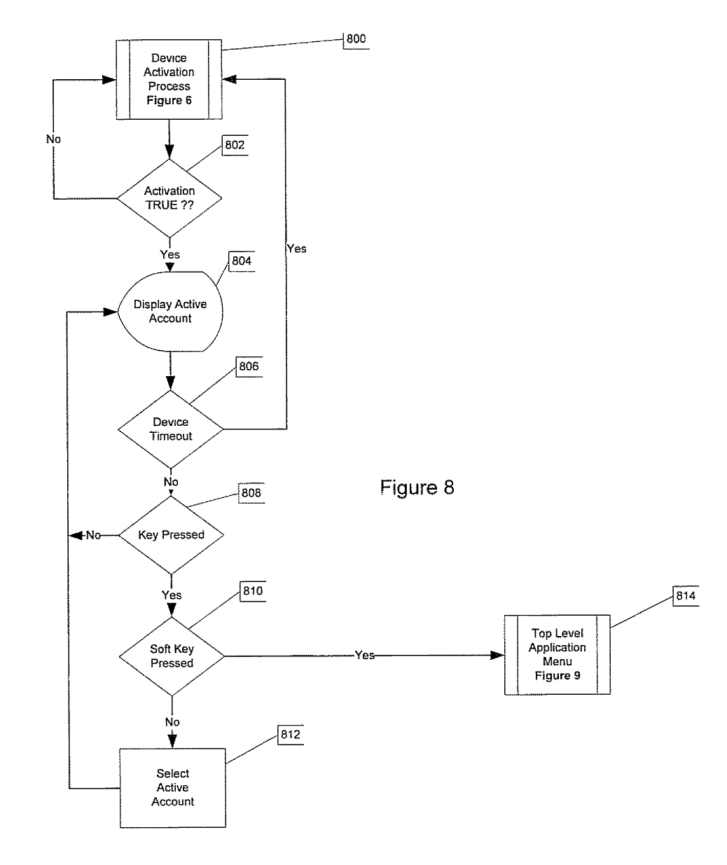

FIG. 6 shows the provisioning process in which account data necessary to complete transactions, and any other data associated with the account or account issuer, such as account issuer logos or graphics, advertising content and/or coupons, is downloaded from an account issuer to device 100 via PC application 1002. Account issuer 601 is typically a bank or other credit card issuer. Account issuer 601 has structured data file 602, containing the information just discussed, with respect to a particular account. PC application 1002, running on a personal computer or other equivalent computing device, establishes secure communication channel 603 with the account issuer 601. Preferably, the secure communication channel would be an HTTPS connection, which uses the HTTP protocol over an encrypted SSL, or TLS transport protocol to insure secured communications with a web server. However, any encrypted secure communications channel may be utilized. Structured data 602 is preferably in the form of an XML document or other structured data file. This structured data would contain the necessary information that is typically encoded in the magnetic stripe or within the memory of a smart card, as well as any auxiliary information. Structured data 602 is downloaded over the secured communication channel 603 to PC application 1002, which will be discussed in more detail later. PC application 1002 communicates with device 100, when device is connected to the PC via a cable or is plugged into base 200 or is near enough to the PC to establish a wireless connection, utilizing the NFC or Bluetooth capabilities.

FIG. 7 shows the process 700 to activate the device for use at a POS terminal. The device activation process 700 is a process by which a user is authenticated, thereby unlocking the various accounts associated with that user. In box 702 it is determined if a biometric is required for this particular user. If so, the user is prompted to perform the biometric scan in box 704, for example, by placing a finger on the fingerprint scanner. The biometric information is collected in box 704 and is analyzed in box 706 by comparing it to the stored biometric template which was gathered during the user enrollment process 500 shown in FIG. 5. In box 708 it is determined if there is a data match found. If no data match is found, the user authentication process 700 returns FALSE and the accounts remain locked. If the collected biometric matches the stored template, the device activation process 700, in box 712 determines if a PIN is also required. In addition for those users for which no biometric is required the authentication process begins in box 712, where the user is prompted to enter the PIN on numeric key pad 103. In box 714, the user enters the PIN if one is required and in box 716 the PIN is compared with the stored PIN for this particular user. If there is a data match in box 718, the process returns TRUE in box 720, indicating that the user has been properly authenticated. If no data match exists, the process returns FALSE in box 710, indicating that the user has not been authenticated. In the event that no pin code is required in box 712 and the user has already been authenticated biometrically, authentication process 700 returns TRUE in box 720.

FIG. 8 shows the upper level flow of control for the device after a user has been authenticated. In box 800, the device activation process of FIG. 7 is performed, returning a value of TRUE or FALSE, indicating a successful authentication or an unsuccessful attempt at authentication, respectively. If the activation process returns TRUE in box 802, control proceeds and the last activated account is displayed as the current active account. If the activation process 700 of FIG. 7 returns FALSE, the device remains locked and awaits a request to perform another device activation. The number of unsuccessful device activation requests that may be performed may be limited, requiring that device 100 be connected to PC application 1002 before another attempt at authentication is made.

If the authentication process is successful, the currently active account is displayed in box 804. The default active account will be the account which was activated last. If the magnetic stripe is present on the device the account information will be programmed into the magnetic stripe for a predetermined amount of time, after which the account will be deactivated. Additionally, or alternatively, the active account information is programmed into the smartcard emulator or the NFC circuitry of the device, such that queries from a smartcard reader or NFC-enabled POS terminal will result in the transmission of the active account information. LCD display 101 may display the name of the account, as well as any associated graphics, such as the logo or trademark of the account issuer. In addition, any auxiliary information necessary to complete the transaction may be displayed. This would include security codes or CCVs, which may be physically printed on a credit card, but not available electronically from the card. Such codes are typically found in the signature panel on the reverse of the card.

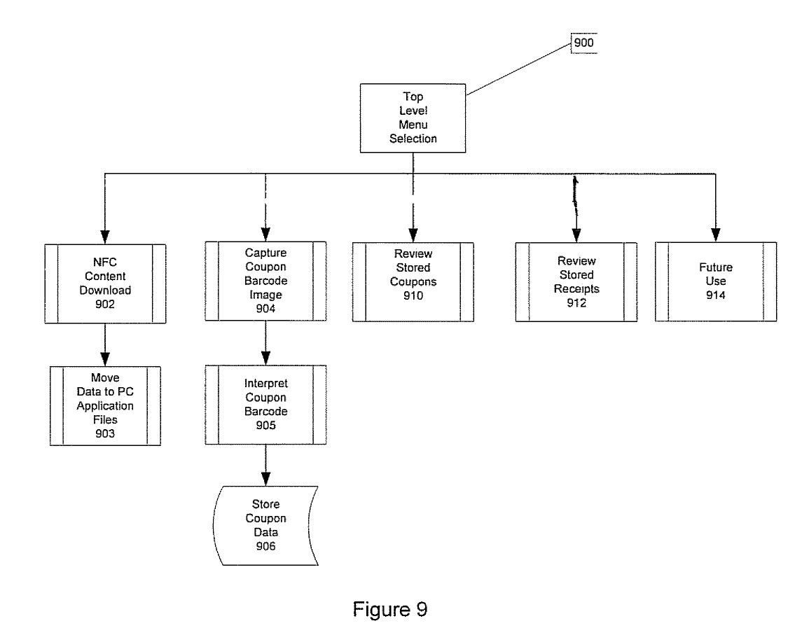

In box 806, it is determined if the currently active account has been timed-out, and, if so, the device becomes deactivated and the device activation process 800 will have to be repeated to reactivate the accounts. If the device is not timed-out, control proceeds to box 808 where it is determined if a key has been pressed, indicating that the user wishes to use the currently active account. If no key has been pressed in box 808, the box continues to display the active account in box 804 and awaits a time-out in box 806. If the device detects a key press, it checks in box 810 to see if soft key 109 has been pressed. If soft key 109 has been pressed in box 810 control proceeds to the top level of the onboard application 900 shown in FIG. 9 at box 814, The onboard application 900 provides access to various functions of the device. If it is not soft key 109 that has been pressed as determined in box 810, control proceeds to a menu where a different active account may be selected in box 812. Once the active account is selected the control returns to box 804 where the active account is again displayed as described above awaiting its use in box 808 or a time-out in box 806.

FIG. 9 shows the top level of the on-board software application 900 shown in FIG. 4. The top level menu of application 900 allows users to select from several functions. In box 902 the user is able to activate the NFC circuitry to download content into the device or from the device to the PC or other near field communications devices. For example, the NFC content download 902 can be used to move data regarding new accounts from the PC to the device 100, in addition data regarding account usage can be downloaded from device 100 to the PC application, such as number of times the account has been used, the amount charged to various accounts, etc. In addition the NFC feature of the device may be used to communicate with POS terminals for other purposes, such as downloading coupons from advertising kiosks, uploading coupons to POS terminals, downloading electronic receipts from POS terminals, downloading product (such as electronic tickets), etc.

In box 904, camera 106 may be used to capture images, including images of barcodes from coupons or other advertising materials, such as posters. To capture the barcode the user takes a picture of the barcode from wherever it is displayed. The barcode is then interpreted in box 905 by software which acts similar to optical character recognition software to interpret the contents of the barcode into plain-text. The details of the coupon are then able to be displayed on LCD display 101. In box 906 the coupon data is stored in on board memory 402 and will be uploaded to PC application 1002 when the device is connected thereto.

The user may choose to review stored coupons box 910 to determine if they may be used or deleted. Similarly, in box 912, user is able to review stored receipts which have been downloaded via the NFC circuitry to memory 402 of device 100. These receipts may eventually be downloaded to PC Application 1002 for permanent storage and/or review and printing. Box 914 is reserved for future expansion of device 100. Future expansion may occur via software updates which occurs via PC application 1002.

A functional diagram of PC application 1002 is shown in FIG. 10. PC application 1002 preferably runs on the computer to which device 100 is connected via a cable or via base 200. Preferably, the computer on which PC application 1002 executes will have a connection to the internet for the downloading of account information from account issuers and the downloading of other content. Thus, PC application 1002 can be of any conventional design for an application of this type as long as the essential functions as laid out in FIG. 10 are provided.

PC application 1002 allows account records to be maintained in box 1004. This includes defining new account records in 1005, modifying existing account records in 1006 and deleting existing account records in 1007. Defining new account records includes the downloading of account information from account issuers in the form of the structured data files, preferably in an XML structure and delivered over any secure HTTPS connection. However, any structure useful in delivering the data from the account issuer to the PC is acceptable. The account information downloaded from the account issuer to the PC may include advertising material or graphics which are to be displayed on the LCD display 101 when the account is activated.

In box 1008, PC application 1002 synchronizes the account data stored thereon and any other content with device 100. PC application 1002 and the storage devices on the PC act as a backup to the information stored on device 100 and will retain historical records retrieved from the device as well as synchronizing all account record data between the device and PC application 1002. An additional level of protection for account data will be managed during the synchronization process. All new account records moved to the device will undergo an encryption process unique to device 100. The encryption process will be conducted by functionality on the device and the newly encrypted account data will be moved back to PC application 1002 to be stored, thereby overwriting the un-encrypted version of the account data This will ensure that the account data created will only function on a single device 100 and no other similar device.

PC application 1002 is also capable of acting as a payment agent for purchases made online, with base 200 acting as the POS and able to use NFC to complete the transaction from device 100. Additionally, if base 200 is not present, then payment can be made directly through the PC from the device using the cable connection or the integrated Bluetooth communications capability. To make an internet payment, device 100 is activated and the appropriate account is selected. When the device 100 is brought into proximity with base 200, or connected to PC application via a physical cable or wireless connection, the account information from device 100 is read and the relevant fields on the webpage are populated to render payment for the online purchase.

PC application 1002 also aids in the management of receipt records by selecting menu item 1012. Receipt records can be downloaded from the device during the synchronization process 1009 and records of the receipts are kept for local storage by the PC application 1002. In box 1013, receipts can be exported as image documents in any well know image formats, such as, for example, JPEG, TIFF, PDF or as a text file. Additionally, records of multiple receipts may be exported in a format suitable for reading by a spreadsheet program such as EXCEL. In box 1014 records may be purged from the local storage when they are no longer needed.

Menu item 1016 enables the coupon management feature of PC application 1002. In box 1018 coupons that the user no longer wants to retain can be purged or, alternatively, coupons which have reached their expiration dates may be purged automatically. In addition, it is possible to download coupons from the internet through PC application 1002 and then send these coupons to the device during synchronization process 1009.

Menu item 1020 enables various configuration options for PC application 1002, such as the method used by the base to communicate with the PC, the format of the user interface for PC application 1002 and a variety of other items.

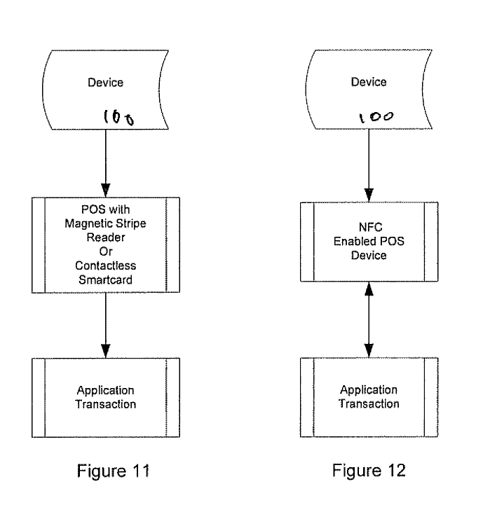

In operation, as shown in FIG. 11, device 100 can be used for transactions utilized with POS terminals utilizing a magnetic stripe. After the user successfully activates the device, the account record data is used to encode the magnetic stripe emulator on the device. The magnetic stripe emulator can then be swiped through a magnetic stripe reader commonly found at POS terminals. This provides the necessary information to complete the transaction in a manner that works with existing equipment. Existing contactless POS terminals interfaces would also support the device as the means to communicate the required transactional data by utilizing the NFC compatibility mode to emulate a contactless smartcard. Therefore, a POS terminal which is able to accept a smartcard will be able to enter into a transaction using the device's NFC capability. This allows for information flow only from device 10 to the POS terminal.

FIG. 12 shows a transaction between a device and an NFC enabled POS device. Here, an interactive session is supported in which the NFC circuitry on the device is able to establish a two-way communication with the NFC-enabled POS terminal to exchange key information regarding the transaction, such as the selected account information, any applicable coupons or special offers, etc. In addition, information is able to be downloaded to device 100 from the POS terminal, such as electronic receipt data, information regarding loyalty points, key points for future purchases, advertising content and messages directed to the users. This capability is not present in the transaction shown in FIG. 11 because there is no channel for data to flow from the POS terminal device back to device 100 via magnetic stripe or smartcard interface.

While it is contemplated that the device contains a portion compliant with ISO standards 7810, 7811, 7812 and 7813 for magnetic stripe cards, it is also contemplated that alternative embodiments will not have the magnetic stripe portion and may only communicate with other devices which utilize smartcard technology or which are NFC-enabled.

Note that the embodiment shown is provided as an exemplar only and the invention is not meant to be limited thereby. For example, actual physical configuration of device 100 may change depending on the needs of the applications which are run thereon. For example, certain applications may require larger or smaller display 101 or certain embodiments in the invention may include, for example, speakers and/or microphones. Likewise, the layout of the interface controls 102 and keypad 103 may be of any configuration that is convenient for the user. Biometric sensor 1105 may be located in any convenient place on or within the housing of device 100. Likewise, the system architecture shown in FIG. 4 is only one possible embodiment. The system architecture may be configured in any manner which provides the functionality necessary for the emulation of magnetic stripes, smartcards and NFC in the manner described herein.

We claim:

1. A device for performing point of sale transactions comprising:
a. memory, for storing information regarding one or more accounts;
b. a user interface, for selecting one of said one or more accounts stored in said memory;
c. an identity verification unit, for verifying the identity of a user of said device; and
d. a communications interface for providing said selected account information in electronic form.

2. The device of claim 1 further comprising a data port, for loading said information regarding one or more a accounts into said memory.

3. The device of claim 1 wherein said user interface comprises:
a. an LCD screen;
b. a numeric keypad; and
c. one or more keys for manipulating a cursor displayed on said LCD screen.

4. The device of claim 3 wherein a list of said accounts is displayed on said LCD screen and further wherein said one or more keys can be used to select one of said accounts from said list of accounts.

5. The device of claim 1 wherein said communications interface is not active until the identity of an authorized user of said device is verified.

6. The device of claim 5 wherein said communications interface remains active for a predetermined period of time after said user's identity is verified.

7. The device of claim 5 wherein said communications interface remains active until said selected account information has been transmitted a predetermined number of times.

8. The device of claim 1 wherein said identity verification unit is selected from a group comprising a fingerprint scanner, a voice recognition unit and a skin pH analyzer.

9. The device of claim 1 wherein said identity verification unit comprises an alphanumeric code entered into said user interface.

10. The device of claim 1 further comprising a housing having a magnetic stripe defined thereon and wherein said communications interface is said magnetic stripe.

11. The device of claim 10 wherein the portion of said housing having said magnetic stripe defined thereon is comparable in thickness to a credit card and can pass through a standard magnetic stripe reader.

12. The device of claim 1 wherein said communications interface is radio frequency based.

13. The device of claim 12 wherein said communications interface is a smartcard interface.

14. The device of claim 12 wherein said communications interface is a near field communications interface.

15. The device of claim 14 wherein said near field communications interface can emulate a smartcard interface.

16. The device of claim 1 wherein a user is authorized to use said device by performing an enrollment process using said user interface and providing a sample authentication token to said identity verification unit.

17. The device of claim 16 wherein said sample identification token is a fingerprint.

18. The device of claim 3 wherein said LCD screen displays secondary information regarding said selected account.

19. The device of claim 18 wherein said secondary information includes an account number and a logo of the issuer of the account.

20. The device of claim 1 further comprising a camera.

21. The device of claim 20 wherein said camera may be used to capture images of a barcode.

22. The device of claim 21 further comprising:
a. software for reading said barcodes captured by said camera and storing the contents of said barcode in said memory; and
b. the capability of displaying the contents of said barcodes in plain text.

23. The device of claim 22 wherein the contents of said barcodes can be uploaded to a point-of-sale terminal via said communications interface.

24. The device of claim 22 wherein said barcodes contain coupon information.

25. The device of claim 14 wherein receipts from transactions made at point-of-sale terminals may be downloaded via said near field communications interface into said memory.

26. The device of claim 14 wherein content may be downloaded into said memory via said near field communications interface.

27. The device of claim 26 wherein said content includes advertising content and coupons.

28. A device for performing point of sale transactions comprising:
a. memory, for storing information regarding one or more accounts;
b. a user interface, for selecting one of said one or more accounts stored in said memory;
c. an biometric scanner, for verifying the identity of a user of said device;
d. a housing having a magnetic stripe defined thereon; and
e. a near field communications interface.

29. The device of claim 28 wherein said magnetic stripe can be programmed on the fly with information regarding said selected account.

30. The device of claim 28 wherein said magnetic stripe is erased a predetermined time after said account has been selected.

31. The device of claim 28 wherein said near field communications interface can be used to upload selected account information to a point-of-sale terminal.

32. The device of claim 31 wherein said near field communications interface can be used to upload coupon information to a point-of-sale terminal.

33. The device of claim 31 wherein said near field communications interface can be used to download content to said device.

34. The device of claim 33 wherein said content includes coupons and electronic receipts.

35. The device of claim 28 further comprising a camera.

36. The device of claim 35 wherein said device can capture images of barcodes via said camera, translate said images of barcodes to plain text and store said plaintext in said memory.

37. A device for performing point of sale transactions comprising:
a. memory, for storing information regarding one or more accounts;
b. a user interface, for selecting one of said one or more accounts stored in said memory;
c. an biometric scanner, for verifying the identity of a user of said device; and
d. a near field communications interface.

38. The device of claim 37 wherein said near field communications interface can be used to upload selected account information to a point-of-sale terminal.

39. The device of claim 38 wherein said near field communications interface can be used to upload coupon information to a point-of-sale terminal.

40. The device of claim 38 wherein said near field communications interface can be used to download content to said device.

41. The device of claim 40 wherein said content includes coupons and electronic receipts.

42. The device of claim 37 further comprising a camera.

43. The device of claim 42 wherein said device can capture images of barcodes via said camera, translate said images of barcodes to plain text and store said plaintext in said memory.

44. A system for performing point-of-sale transactions comprising:
a. a computer running an application; and
b. a handheld component comprising:
memory, for storing information regarding one or more accounts;
a user interface, for selecting one of said one or more accounts stored in said memory;
an identity verification unit, for verifying the identity of a user of said device;
a communications interface for providing said selected account information in electronic form; and
a data port for communicating with said application; and

45. The system of claim 44 wherein said application can download account information from account issuers and store said account information on said computer.

46. The system of claim 45 wherein said account information can be downloaded to said handheld component and stored in said memory therein.

47. The system of claim 45 wherein said account information is downloaded to said handheld component, encrypted on said handheld component, and sent back to said application for storage on said computer.

48. The system of claim 44 wherein said application can download content to said handheld component.

49. The system of claim 48 wherein said content includes advertising and coupons.

50. The system of claim 44 wherein said communications interface is a near field communications (NFC) interface.

51. The system of claim 50 wherein said NFC interface can emulate a smartcard to enable contactless transactions with smartcard enabled point-of-sale terminals.

52. The system of claim 50 wherein said handheld device can communicate with point-of-sale terminals which are also NFC-enabled.

53. The system of claim 52 wherein said handheld component can receive electronic receipts from NFC-enabled point-of-sale terminals.

54. The system of claim 53 wherein said electronic receipts can be downloaded to said application for storage.

55. The system of claim 54 wherein said application can output said electronic receipts.

56. The system of claim 44 wherein said handheld component can download coupons and advertising content from NFC-enabled portals.

57. The system of claim 56 wherein said coupons can be sent to said application via said data port for storage.

58. The system of claim 57 wherein said application allows a user to delete coupons or can automatically remove coupons when they have expired.

59. The system of claim 44 wherein said handheld component can be electronically coupled with said computer, allowing synchronization between said application and said handheld component.

60. The system of claim 59 wherein data stored on said handheld component minors data stored by said application.

61. The system of claim 60 wherein said handheld component couples to said application running on a computer via a cable.

62. The system of claim 44 further comprising a base unit coupled to said computer via a cable, said base unit having a connector capable of mating with said data port on said handheld component.

63. The system of claim 62 wherein said base unit is NFC-enabled, such that said base unit can act as a point-of-sale terminal for purchased made on internet commerce sites via said computer.

64. The system of claim 44 wherein said handheld component further comprises a housing having a magnetic stripe disposed on a portion thereof said portion being of a thickness such that said magnetic stripe is able to be read by a standard magnetic stripe reader.

65. The system of claim 63 wherein said magnetic stripe can be programmed with said selected account information on the fly, and further wherein said selected account information is erased from said magnetics stripe after a predetermined period of time.

66. The system of claim 44 wherein said handheld component further comprises a camera.

67. The system of claim 66 wherein said camera can be used to capture and store images of barcodes.

68. The system of claim 67 wherein said handheld component can interpret said barcodes captured by said camera into plain-text.

69. The system of claim 44 further comprising a rechargeable battery disposed in said handheld component.

70. The system of claim 69 wherein said rechargeable battery may be inductively re-charged via an RF antenna.
